(19) United States
(12) Patent Application Publication
(10) Pub. No.: US 2012/0294437 A1
(43) Pub. Date: Nov. 22, 2012

(54) AUTOMATIC GAIN CONTROL FOR TELE-PRESENCE VOICE ECHO CANCELLERS

(75) Inventors: Tariq HADDAD, Kanata (CA); Gary Q. JIN, Kanata (CA)

(73) Assignee: MICROSEMI SEMICONDUCTOR CORP., Kanata (CA)

(21) Appl. No.: 13/473,864

(22) Filed: May 17, 2012

(30) Foreign Application Priority Data
May 18, 2011 (GB) 1108340.9

(51) Int. Cl. H04M 9/08

(52) U.S. Cl. 379/406.05

(57) ABSTRACT

In a closed loop acoustic system with forward and return paths, gain is controlled with different instantiations of a common gain control engine on each path. The gain control engine computes a first gain based on near-end signal levels, computes a second gain based on the output of the gain control engine, computes a third gain based on a howling condition, and computes a final gain as the product of the first, second and third gains.

### FIELD OF THE INVENTION

This invention relates to the field of signal processing, and in particular to an automatic gain control for adaptive speech echo cancellation, specifically to acoustic echo cancellation for loud speaking telephones, hands free car sets and voice conferencing systems. The invention also applies also to line echo cancellers.

### BACKGROUND OF THE INVENTION

An automatic gain control (AGC) systems, also known as an automatic level control (ALC) in some telecommunication applications, are used in multi-microphone high definition acoustic echo cancellation systems, for example, desktop phone devices, hands free car kits and the tele-presence (conferencing) systems. An automatic gain or level control is used to maintain constant signal level by varying the gain as a function of the input signal power as shown in FIG. 1.

ITU-T G.169 states the desired features of ALC systems for telecommunication networks, but the standard does not enforce a particular design approach. The G.169 standard specifies a few tests that would insure the integrity of speech, voice-band data and signaling tones. Those standard tests also insure that the network gain or level control device will not change the levels of background noise or residual echo signals.

Existing automatic gain control systems suffer from a number of problems. They only work with signals that has small peak to average ratio (PAR). This is often not the case in speech systems. When the PAR is large, current solutions distort the desired signal by rapid update of the system gain, which also induces system howling. There is no return path, and yet the acoustic echo system has a return path. They do not control system howling, which is associated with closed loop systems.

Moreover, current solutions do not accommodate system silent periods, such that the gain might amplify background noise, which is also a factor induced system howling. They also amplify echo return loss (ERL) when it is smaller than 0 dB, which causes microphone saturation instead of speaker saturation, and suffer from lack of howling control.

### SUMMARY OF THE INVENTION

Embodiments of the invention provide an effective automatic gain control as per the recommendations of ITU-T G.169 using several status signals from the voice echo cancellation system to decide on the gain levels in a unique integrated approach. A complete signal level control block in the acoustic closed loop system functions to deliver acceptable signal levels with nonstationary speech signals while preventing system howling.

According to the present invention there is provided a method of controlling gain in an acoustic system with a gain control module, comprising computing a first gain based on near-end signal levels; computing a second gain based on the output of the gain control module; computing a third gain based on a howling condition; and computing a final gain applied to the gain control module as the product of the first, second and third gains.

Embodiments of the invention control the amount of increase and reduction of the gain applied to the signals on the near-end and far-end paths of the acoustic echo cancellation system. The user can set a predetermined range of gain to be applied to the near-end signal. On the far-end path, the AGC will control the level of the input signal, which is used as a reference to the adaptive cancellation filter. The invention can be used with the other elements of the echo cancellation system, such as beamforming, noise reduction and filtering, to improve the overall speech quality of echo cancellation systems.

### BRIEF DESCRIPTION OF THE DRAWINGS

The invention will now be described in more detail, by way of example only, with reference to the accompanying drawings, in which:—

FIG. 1 shows the gain as a function of input signal in an automatic gain control circuit;

FIG. 2 is a block diagram of a tele-presence voice echo cancellation system;

FIG. 3 shows a first embodiment of gain control engine in accordance with the principles of the invention;

FIG. 4 shows a second embodiment of a gain control engine in accordance with the principles of the invention; and

FIG. 5 shows a second embodiment of gain control engine in accordance with the principles of the invention.

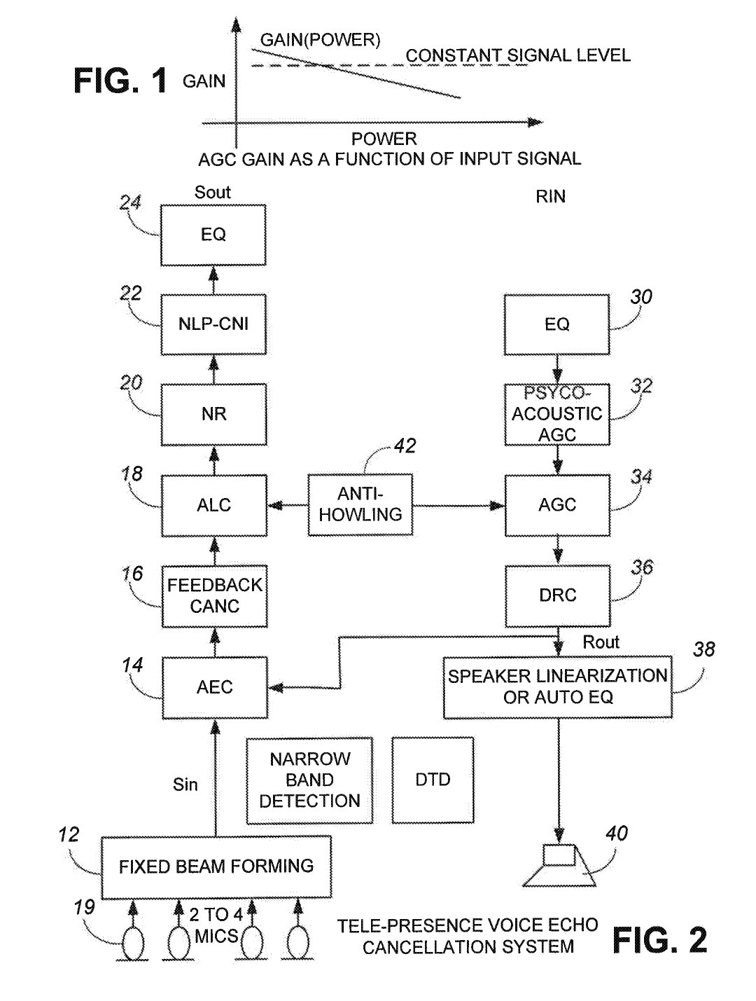

### DETAILED DESCRIPTION OF THE INVENTION

In the discussion that follows the following variables will be referred to:
Rin: far-end input signal.
Sin: near-end input signal.
Rout: near-end output signal.
Sout: far-end output signal.
ALCi: input signal to ALC.
G: total gain of the Automatic gain control system.
G1: near-end gain.
G2: far-end gain.
HG: howling gain.
Pout: average power of the AGC/ALC output signal, Rout for AGC and Sout for ALC.
Pi1: For AGC is Sin power. For ALC it is the ALC block input (adaptation error signal) power.
Pout0: Rout power for the AGC and the adaptation error signal power for the ALC.
TH1: Pout user defined power threshold.
TH2: Pi1 and Pout0 user defined power threshold.
TH3=0x1000_{—}0000.
TH4=0x2000_{—}0000.
TH5: A logical variable.
TH6=0x4000.
TH7=0x2000_{—}0000.
TH8=0x2000_{—}0000.
AGCUP: a programmable gain increment step size.
Counter: hand over timer.

Embodiments of the invention introduce a method for controlling the gain on the near-end and far-end paths of an acoustic echo cancellation system. The same control engine is called independently to control the gain on both paths. For distinction, the block on the far-end path will be referred to as an AGC, while the block on the near-end path will be referred to as ALC. The only difference between the two blocks is the input/output signals and the top level control, as shown in FIG. 2.

FIG. 2 shows top level block diagram of one embodiment of tele-presence echo cancellation system, which includes two instantiations of a gain control engine as an AGC on the receive path and an ALC on the send (near end) path. Both blocks use the same gain control engine, however using different top level state-machine control logic. In FIG. 2, an array of microphones are coupled to beamformer 12. The microphone signals from the beamformer 12 are passed successively through acoustic echo controller 14, feedback canceler 16, automatic level control 18, noise reducer 20, non-linear processor 22 and equalizer 24.

Received signals are passed successively through equalizer pysychoacoustic AGC 32, automatic gain control 34, speaker linearization block 36, and dynamic range control block 38 to speaker 40. Anti howling unit 42 is connected between ALC 18 and AGC 34.

The main gain control value is divided into three gain elements to take into account the different factors that influence a closed loop acoustic echo cancellation system. The gains are:

1. G1: representing the gain part that changes based on the near-end signal levels (Sin).
2. G2: representing the gain part that changes based on the output of the gain control block, which is (Rout) for the AGC and the far-end output signal (Sout) for the ALC.
3. HG: representing the howling gain. The anti-howling block in the echo cancellation system reduces this gain based on a howling condition, and the gain control engine (AGC/ALC) brings back this gain in normal conditions.

Then, the total gain G is computed as follows

G=G₁G₂HG

The output signal of the gain control block is generated by multiplying this gain value G by the input signal. The core gain control engine provides a total of 18 dB dynamic range. In this design the value of 0x4000 corresponds to unity gain. Thus, multiplication result at the AGC output is shifted right by 13 to generate the 16-bit Rout signal. This corresponds to a maximum of 6 dBAGC gain. The ALC output (Sout), on the other hand is shifted by a programmable value to produce the desired maximum ALC Gain level (13 for 4-6 dB, 12 for 12 dB, etc.).

The description will be divided into the control logic and the gain control engine as shown in FIG. 2.

### ALC Control Logic

The following is the ALC control sequence:

1. Compute Pi1 and Pout0 directly as the power of the input signal to the ALC block (ALCi),
2. Check if the system None-linear-processor (NLP) is active. If the NLP is active, skip the ALC engine call, and go to step 6 of this sequence.
3. Generate a logical variable TH5=˜[(Rin active)&&˜(Sin active)].
4. Call the Gain control engine.
5. Read back total G and generate the output G×ALCi.
6. Compute Pout as the power of the Sout signal for the next call of the ALC control logic sequence.

### AGC Control Logic

The following is the AGC control sequence:

1. Compute Pi1 as the power of the input signal Sin.
2. Compute Pout0 and Pout as the power of the Rout signal.
3. Generate a logical variable TH5=(Rin active).
4. Call the Gain control engine.
5. Read back total G and generate the output G×Rin.

### Gain Control Engine

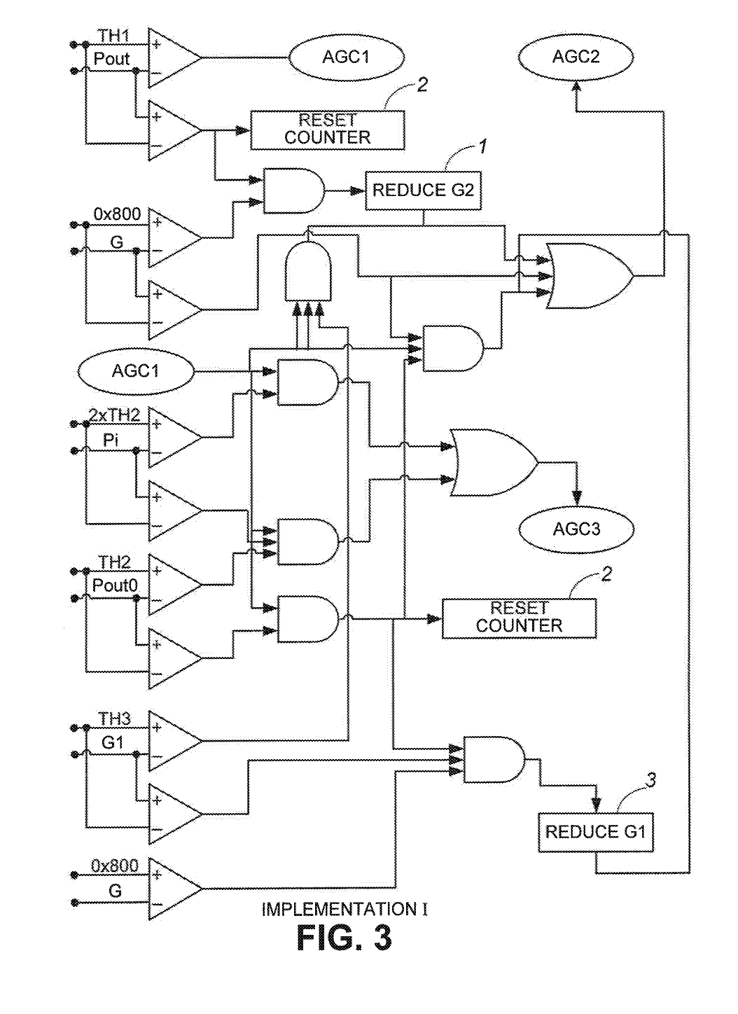

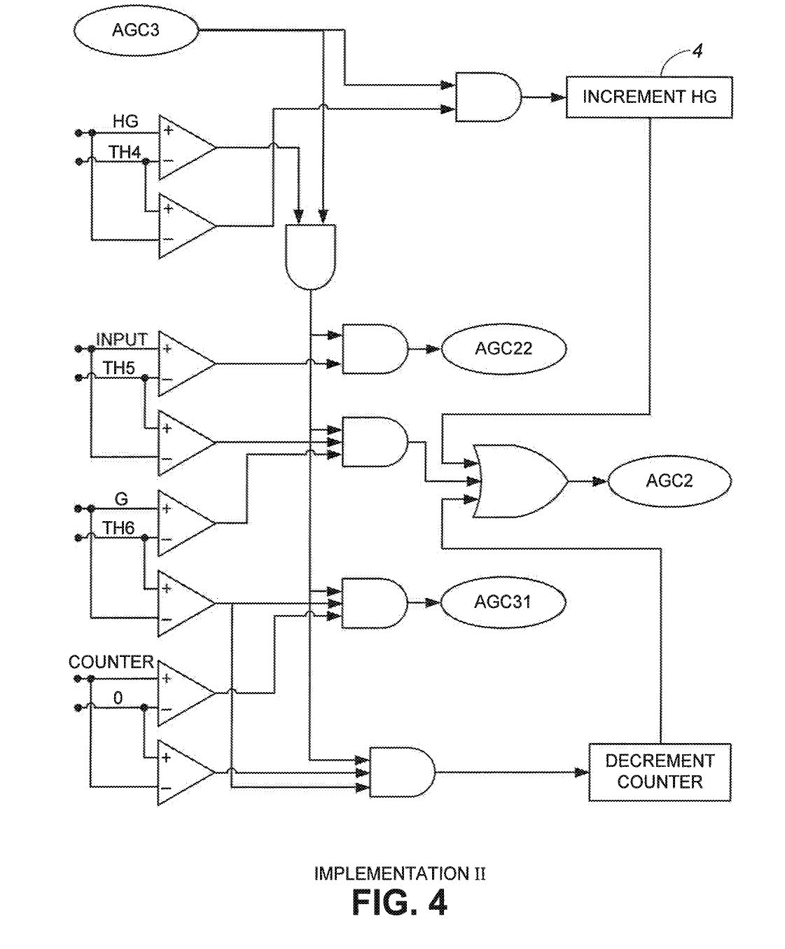

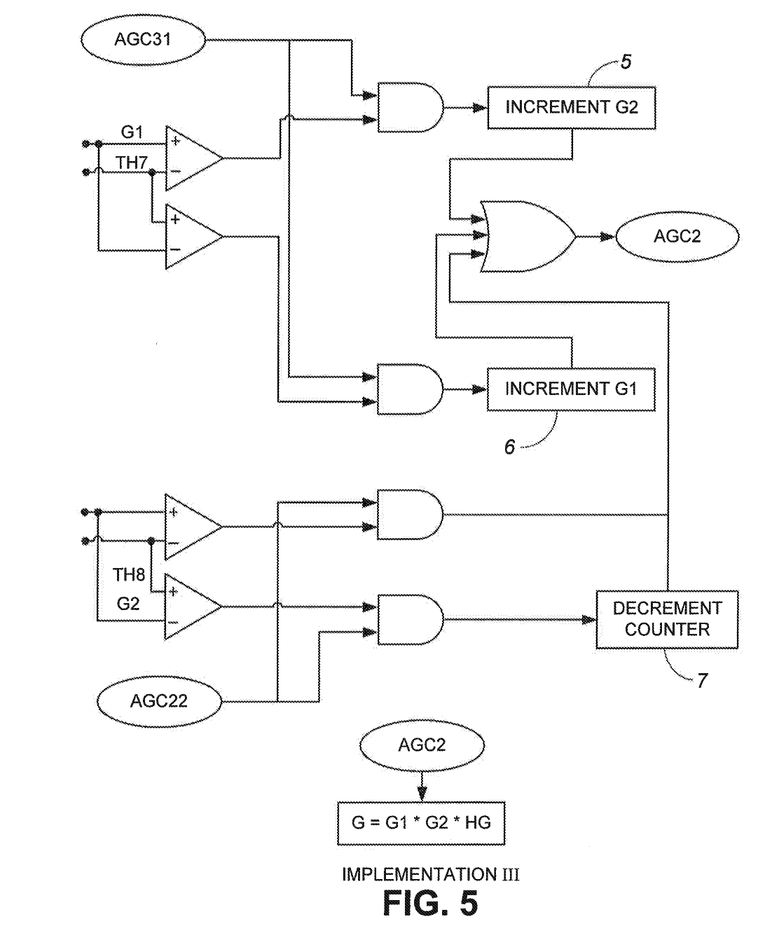

The detailed implementation of the gain control engine is described in FIG. 3, FIG. 4 and FIG. 5. In this embodiment, the AGC and ALC gain are adjusted according to the described procedures. The algorithms are illustrated in terms of comparators, gates and counters as shown.

In FIGS. 3 to 5, AGCx, where x=0, 1, 2, 3, represents a junction state where the algorithm performs a specific function.

AGC0 is the start state. If the AGC engine output power is “large”, i.e. above a predetermined threshold, the algorithm resets the handover counter which resets the period before the first gain increase (speed of increase) and reduces the far-end gain part (G2), which is related to the AGC input signal.

Then the algorithm moves to exit state AGC2. Otherwise (for low power), we need to increase the total gain, so we go to state AGC1.

### AGC1 (Intermediate State):

In this state the algorithm measures the near-end power and the return-echo power. If both values are large, reset the handover counter is reset. Since there is an increase in near-end signal powers, the near-end gain component (G1) is reduced. Then the algorithm jumps to exit state AGC2. Otherwise (for low power), a gain increase is required, so the algorithm continues to state AGC3.

### AGC3 (System State):

The following steps are performed in priority. Each step leads to exit state AGC2 if the condition is satisfied.

The algorithm checks first to increase the howling gain (HG). If it is “small”, then it gets incremented and the algorithm jumps to the exit state AGC2. Before changing the other two components of the total gain, HG is incremented to determine the impact on the system during the next few voice samples.

If the far end signal is not active for AGC (noise level detection) or double talk is detected for ALC we need to reduce the far-end gain component (G2), which is the only task performed in state AGC22, then the algorithm exits to state AGC2. Reducing the far end component of the total gain is intuitive since the far end signal does not exist and it is important not to increase the gain on purely noise signals. If the total gain is “large”, the algorithm just exits to AGC2.

A check is made to see if the handover time (counter) has been crossed; if yes the algorithm jumps to the gain increase state (AGC31), otherwise, the counter and the algorithm exits to state AGC2. This handover counter is an important solution to dealing with larger peak to average ratio in speech signals. It prevents a sudden reaction to any sudden change in signal power levels.

AGC31 (G1 and G2 Increase State):

Increment the values of these two gain components according to the programmable speed value.

### AGC2 (Exit State):

Compute total gain and exit.

AGC0 in FIG. 3:

1) If Pout>TH1 then reset the counter with the user programmable value (2), which works as the gain handover time for smooth gain update. If Pout<TH1 go to AGC1.
2) If G>0x800 then reduce G2 (1) as follows. G2=G2(1−2⁻¹¹). Then go to AGC2. If G<0x800, go to AGC2.

AGC1 in FIG. 3:

1) if (Pi1>2×TH2) and (Pout0>TH2) then reset the counter with the user programmable value (2). Otherwise go to AGC3.
2) If (G>0x800) and (G1>TH3) then reduce G1 (3) as follows then go to AGC2. Otherwise, go to AGC2.

AGC3 in FIG. 4,

1) If (HG<TH4) then increment HG (4) as follows HG=HG(1+2⁻¹⁸AGCUP), then go to AGC2.
2) If (TH5), which is described in the control logic part, is logical zero, then go to AGC22,
3) if (G>TH6) then go to AGC2.
4) If (Counter==0) go to AGC31, otherwise decrement Counter and go to AGC2.

AGC31 in FIG. 5

1) If (G1<TH7) increment G1 (6) as follows G1=G1(1+2⁻¹⁸AGCUP), then go to AGC2.
2) Increment G2 (5) as follows G2=G2(1+2⁻¹⁸AGCUP), then go to AGC2.

AGC22 in FIG. 5

1) if (G2<TH8) then reduce G2 (7) as follows G2=G2(1+2⁻¹¹), otherwise, go to AGC2.

AGC22 in FIG. 5,

### 1) Compute G=G1·G2·HG.

The algorithm utilizes noise level status, double talk status and average signal power to increase or decrease signal levels in the forward and return paths of the closed loop system. The level control is performed using different up and down speeds, which is essential for speech signals with large peak to average ratio. Embodiments of the invention provide an integrated automatic level control procedure for closed loop voice systems in reverberant environments.

Novel aspects of invention include a new method for gain level control in acoustic systems, a new algorithm for gradual adaptation of the path gain levels through dividing the gain into three elements, each controlled by specific system signals, controlled gain increase speed through a programmable hand over counter and gain step size, and the inclusion of an anti-howling gain factor in the over all adaptive gain control engine. Embodiments of the invention control the increase of the howling gain through gain levels and programmable step size. Also, the same gain control engine is used on both near-end and far-end paths by passing the corresponding relevant path control and status bits.

Thus, in accordance with embodiments of the invention that the gain is controlled with different up and down speeds, noise level and double talk detection is used so that the gain is unchanged during system quite periods, use is made of the signal power on both the forward and the return paths to provide a complete solution. The howling gain is also controlled.

The invention is applicable to any acoustic echo cancellation environment, such as hands free car kits, wireless applications and desktop phones.

It should be appreciated by those skilled in the art that any block diagrams herein represent conceptual views of illustrative circuitry embodying the principles of the invention. For example, a processor may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. The term circuit is used herein to encompass functional blocks that may in practice be implemented in software.

1. A method of controlling gain in a closed loop acoustic system with forward and return paths, comprising controlling gain with different instantiations of a common gain control engine on each path, and wherein the gain control engine:
computes a first gain based on near-end signal levels;
computes a second gain based on the output of the gain control engine;
computes a third gain based on a howling condition; and
computes a final gain as the product of the first, second and third gains.

2. A method as claimed in claim 1, wherein noise level status, double talk status and average signal power are used to increase or decrease signal levels in the forward and return paths of the closed loop system.

3. A method as claimed in claim 1, wherein the near-end and far-end gains are computed based on activity of activity status of input and output signals of the system.

4. A method as claimed in claim 1, wherein the gain is based on a programmable set of power thresholds.

5. A method as claimed in claim 1, wherein the gain is controlled with different up and down speeds.

6. A method as claimed in claim 1, wherein the gain control engine uses the signal power on both the forward and return paths as inputs.

7. A method as claimed in claim 1, wherein level and double talk protection is applied so that the gain is unchanged during quiet periods.

8. A method as claimed in claim 1, which has a plurality of states ACGx as follows:
AGC0 (start state): If the output power is above a predetermined threshold, reset a handover counter which resets the period before the first gain increase (speed of increase) and reduces the far-end gain part (G2), which is related to the AGC input signal, reset the handover counter to a default value, and then move to exit state AGC2; otherwise go to state AGC1;
AGC1 (intermediate state): measure the near-end power and the return-echo power; if both values are large, reset the handover counter to the near-end gain component (G1) and then jump to exit state AGC2; otherwise go to state AGC31;
AGC3 (System state): perform the following steps in priority wherein each step leads to exit state AGC2 if the condition is satisfied:
Checks first to increase the howling gain (HG); if it is less than a predetermined threshold, then incremented and jump to the exit state AGC2; before changing the other two components of the total gain, incremented howling gain to determine the impact on the system during the next few voice samples; if the far end signal is not active for AGC (noise level detection) or double talk is detected for ALC reduce the far-end gain component (G2), which is the only task performed in state AGC22, then the algorithm exit to state AGC2;
check to see if the handover time (counter) has been crossed; if yes the algorithm jumps to the gain increase state (AGC31), otherwise decrement the counter and exit to state AGC2;
AGC31 (G1 and G2 increase state): increment the values of these two gain components according to the programmable speed value;
AGC2 (Exit state): Compute total gain and exit.

9. A gain control engine for controlling gain in a closed loop acoustic system with forward and return paths, wherein the gain is controlled with different instantiations of a common gain control engine on each path, comprising:
a module for computing a first gain based on near-end signal levels;
a module for computing a second gain based on the output of the gain control engine;
a module for computing a third gain based on a howling condition; and
a module for computing a final gain as the product of the first, second and third gains.

10. A gain control engine as claimed in claim 9, which is configured such that noise level status, double talk status and average signal power are used to increase or decrease signal levels in the forward and return paths of the closed loop system.

11. A gain control engine as claimed in claim 10, which is configured such that the near-end and far-end gains are computed based on activity of activity status of input and output signals of the system.

12. A gain control engine as claimed in claim 9, which is configured such that the gain is based on a programmable set of power thresholds.

13. A gain control engine as claimed in claim 9, which is configured such that the gain is controlled with different up and down speeds.

14. A gain control engine as claimed in claim 9, wherein the gain control engine uses the signal power on both the forward and return paths as inputs.

15. A gain control engine as claimed in claim 1, which applies level and double talk protection so that the gain is unchanged during quiet periods.

16. A gain control engine as claimed in claim 9, which has a plurality of states ACGx as follows:
AGC0 (start state): If the output power is above a predetermined threshold, reset a handover counter which resets the period before the first gain increase (speed of increase) and reduces the far-end gain part (G2), which is related to the AGC input signal, and then move to exit state AGC2; otherwise go to state AGC1;
AGC1 (Intermediate state): measure the near-end power and the return-echo power; if both values are large, reset the handover counter to the near-end gain component (G1) and then jump to exit state AGC2; otherwise (for low power), go to state AGC31;
AGC3 (System state): perform the following steps in priority wherein each step leads to exit state AGC2 if the condition is satisfied: Checks first to increase the howling gain (HG); if it is less than a predetermined threshold, then incremented and jump to the exit state AGC2; before changing the other two components of the total gain, incremented howling gain to determine the impact on the system during the next few voice samples; if the far end signal is not active for AGC (noise level detection) or double talk is detected for ALC reduce the far-end gain component (G2), which is the only task performed in state AGC22, then the algorithm exit to state AGC2; check to see if the handover time (counter) has been crossed; if yes the algorithm jumps to the gain increase state (AGC31), otherwise, exit to state AGC2;
AGC31 (G1 and G2 increase state): Increment the values of these two gain components according to the programmable speed value;
AGC2 (Exit state): Compute total gain and exit.
